(19) United States
(12) Patent Application Publication
(10) Pub. No.: US 2014/0085641 A1
(43) Pub. Date: Mar. 27, 2014

(54) METHOD AND APPARATUS FOR RECOGNIZING LOCATION OF PILED OBJECTS

(71) Applicant: Electronics and Telecommunications Research Institute, Daejeon (KR)

(72) Inventors: Joo Chan SOHN, Daejeon (KR); Jae Min BYUN, Gyeryong-si (KR); Ki In NA, Daejeon (KR); Myung Chan ROH, Daejeon (KR); Sung Hoon KIM, Daejeon (KR)

(73) Assignee: Electronics and Telecommunications Research Institute, Daejeon (KR)

(21) Appl. No.: 14/028,997

(22) Filed: Sep. 17, 2013

(30) Foreign Application Priority Data
Sep. 27, 2012 (KR) 10-2012-0108359
Aug. 14, 2013 (KR) 10-2013-0096866

(51) Int. Cl. G01B 11/14

(52) U.S. Cl. CPC G01B 11/14
USPC 356/614

(57) ABSTRACT

A piling location recognizing apparatus and method for accurately determining a piling location using an optical sensor. The piling location recognizing apparatus includes an optical sensor moving unit configured to move on an installed moving line according to a predetermined angle with respect to a recognition target object, an optical sensor recognizing unit mounted on the optical sensor moving unit to acquire information on the recognition target object using an optical sensor, and a piling location calculating unit configured to calculate vertical location coordinates of the recognition target object on a basis of the acquired information on the recognition target object. Accordingly, despite environmental pollution or damage of an identification tag adhered to an object in a piling place in which objects are piled up, an in-yard location of the piled object can be accurately determined.

### CLAIM FOR PRIORITY

This application claims priority to Korean Patent Application No. 10-2012-0108359 filed on Sep. 27, 2012 and Korean Patent Application No. 10-2013-0096866 filed on in Aug. 14, 2013 the Korean Intellectual Property Office (KIPO), the entire contents of which are hereby incorporated by reference.

### BACKGROUND

1. Technical Field

Example embodiments of the present invention relate in general to technology for recognizing a piling location, and more specifically, to a piling location recognizing apparatus and method for accurately determining a location of piled objects using an optical sensor.

2. Related Art

Large components which are manufactured at a manufacturing site for manufacturing large apparatuses (for example, ships, plants, etc.) have a difficulty in manipulation and piling due to their size and weight. In the manufactured large components, since the large components are piled up in a yard to be exposed to climate change as-is, a printed identification mark is polluted and corroded, or the identification mark is damaged due to climate change.

In addition, it is difficult to adhere an identification mark to a component due to a flat-type characteristic of the component, and in piling up components using a method of piling up the components from an upper end to a lower end, it is difficult to identify a desired component due to a limitation of identification mark recognition, and it is difficult to accurately manage the stock of components and to trace a location of the components.

To solve such problems, research and development are being done on a component identification method using a radio frequency (RF) identification tag and an RF identification tag reader.

However, a problem of application is caused by a component characteristic of ships and large plants, and it is difficult to apply the component identification method using the RF identification tag and the RF identification tag reader at a manufacturing site due to a problem of a signal recognition distance of a manual RF identification tag, a battery problem of an active RF identification tag, and a problem that an error of recognizing a piling location occurs due to an RE radio wave characteristic.

### SUMMARY

Accordingly, example embodiments of the present invention are provided to substantially obviate one or more problems due to limitations and disadvantages of the related art.

Example embodiments of the present invention provide a piling location recognizing apparatus for accurately determining a location of piled components despite pollution, damage, or the like of an identification tag.

Example embodiments of the present invention also provide a piling location recognizing method for accurately determining a location of piled components despite pollution, damage, or the like of an identification tag.

In some example embodiments, a piling location recognizing apparatus includes: an optical sensor moving unit configured to move on an installed moving line at 360 degrees with respect to a recognition target object; an optical sensor recognizing unit mounted on the optical sensor moving unit, and configured to acquire information on the recognition target object using a plurality of optical sensors, the optical sensor recognizing unit including the plurality of optical sensors; and a piling location calculating unit configured to calculate vertical location coordinates of the recognition target object on a basis of the acquired information on the recognition target object.

The optical sensor recognizing unit may include: a multi-channel sensor module configured to radiate source light on the recognition target object and receive the source light returning from the recognition target object; and an object information acquiring module configured to acquire at least one of distance information to the recognition target object, area information of the recognition target object, shape information of the recognition target object, and height information of the recognition target object using the recognized source light.

The multi-channel sensor module may adjust a number of channels and a disposition interval between optical sources to adjust resolution.

The piling location calculating unit may include: a vertical location coordinate calculating module configured to calculate vertical location coordinates of the recognition target object using the height information of the recognition target object, and transmit the calculated vertical location coordinates of the recognition target object to a piling management system that manages a plurality of objects; and a vertical location coordinate storing module configured to store the calculated vertical location coordinates of the recognition target object.

When the recognition target object is piled up at a place in which other objects having a specific height are piled up, the vertical location coordinate calculating module may calculate a height, which is obtained by adding a height of the recognition target object to the specific height, as vertical location coordinates of the recognition target object.

The piling location recognizing apparatus may further include an identification tag recognizing unit configured to detect an identification tag of the recognition target object, and match the detected identification tag with the vertical location coordinates of the recognition target object to calculate piling location information of the recognition target object and detect a unique ID of the recognition target object.

The identification tag recognizing unit may transmit the calculated piling location information to a piling management system that manages a plurality of objects.

In other example embodiments, a piling location recognizing method includes: moving at 360 degrees with respect to a recognition target object to acquire information on the recognition target object using an optical sensor; and calculating vertical location coordinates of the recognition target object on a basis of the acquired information on the recognition target object.

The piling location recognizing method may further include recognizing the information on the recognition target object; radiating source light on the recognition target object; receiving the source light returning from the recognition target object; and acquiring at least one of distance information to the recognition target object, area information of the recognition target object, shape information of the recognition target object, and height information of the recognition target object using the recognized source light.

The recognizing of the information may include adjusting a number of channels and a disposition interval between optical sources to adjust resolution.

The calculating of vertical location coordinates may include, when the recognition target object is piled up at a place in which other objects having a specific height are piled up, calculating module calculates a height, which is obtained by adding a height of the recognition target object to the specific height, as vertical location coordinates of the recognition target object.

The piling location recognizing method may further include: detecting an identification tag of the recognition target object; matching the detected identification tag with the vertical location coordinates of the recognition target object; and calculating piling location information of the recognition target object, and detecting a unique ID of the recognition target object according to the matched result.

The piling location recognizing method may further include, after the calculating of piling location information of the recognition target object and the detecting of a unique ID, transmitting the calculated vertical location coordinates and piling location information to a piling management system.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a configuration of a piling location recognizing apparatus according to an embodiment of the present, invention;

FIG. 2 is a conceptual diagram illustrating an operating environment of an optical sensor moving unit according to an embodiment of the present invention;

FIG. 3 is a block diagram illustrating modules configuring an optical sensor recognizing unit according to an embodiment of the present invention;

FIG. 4 is a conceptual diagram illustrating an operation performed in the optical sensor recognizing unit according to an embodiment of the present invention;

FIG. 5 is a block diagram illustrating modules configuring a piling location calculating unit according to an embodiment of the present invention;

FIG. 6 is a conceptual diagram illustrating an environment in which vertical location coordinates of an object are calculated in the piling location calculating unit according to an embodiment of the present invention;

FIG. 7 is a conceptual diagram illustrating an environment in which piling location information and a unique identifier (ID) of an object are detected in an identification tag recognizing unit according to an embodiment of the present invention; and

FIG. 8 is a flowchart illustrating a piling location recognizing method according to an embodiment of the present invention.

### DESCRIPTION OF EXAMPLE EMBODIMENTS

Since the present invention may have diverse modified embodiments, preferred embodiments are illustrated in the drawings and are described in the detailed description of the invention.

However, it should be understood that the particular embodiments are not intended to limit the present disclosure to specific forms, but rather the present disclosure is meant to cover all modification, similarities, and alternatives which are included in the spirit and scope of the present disclosure.

Relational terms such as first, second, and the like may be used for describing various elements, but the elements should not be limited by the terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

In the following description, the technical terms are used only for explaining a specific exemplary embodiment while not limiting the present disclosure. The terms of a singular form may include plural forms unless referred to the contrary. The meaning of “comprise,” “include,” or “have” specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that, are generally used and have been in dictionaries should be construed as having meanings matched with contextual meanings in the art. In this description, unless defined clearly, terms are not ideally, excessively construed as formal meanings.

Embodiments of the present invention will be described below in more detail with reference to the accompanying drawings. In describing the invention, to facilitate the entire understanding of the invention, like numbers refer to like elements throughout the description of the figures, and a repetitive description on the same element is not provided.

Elements to be described below are elements defined not by physical properties but by functional properties. Thus, each element may be defined by its function. Each element may be implemented as hardware and/or a program code and a processing unit for performing its function. The functions of two or more elements may be implemented to be included in one element.

Accordingly, it should be noted that names of elements in an embodiment to be described below are not given to physically classify the elements but given to imply representative functions performed by the elements, and the technical spirit of the present invention is not limited by the names of the elements.

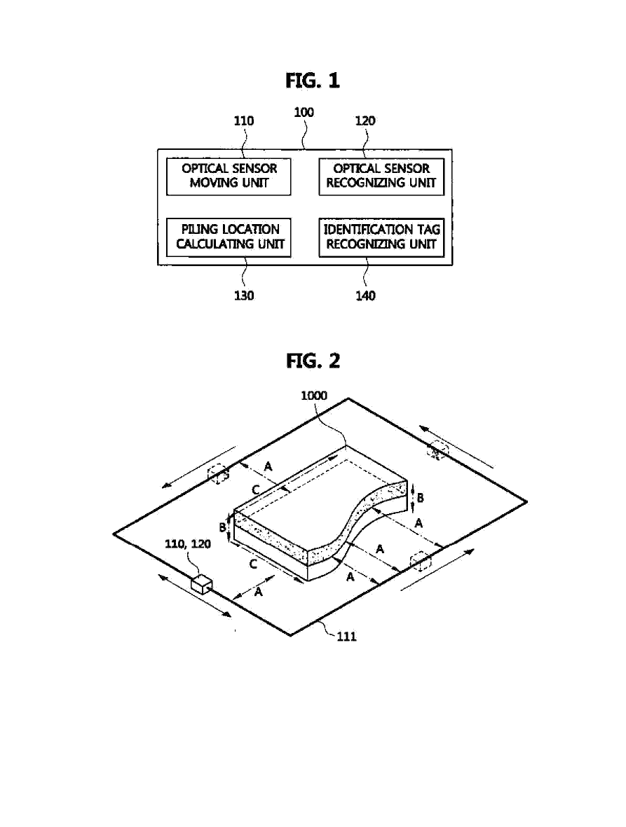

FIG. 1 is a block diagram illustrating a configuration of a piling location recognizing apparatus according to an embodiment of the present invention.

Referring to FIG. 1, a piling location recognizing apparatus 100 according to an embodiment of the present invention may include an optical sensor moving unit 110 that moves according to a predetermined angle with respect to a recognition target object, an optical sensor recognizing unit 120 that is mounted on the optical sensor moving unit 110 to acquire information on the recognition target object, a piling location calculating unit 130 that calculates vertical location coordinates of the recognition target object, and an identification tag recognizing unit 140 that calculates piling location information of the recognition target to object and detects a unique identifier (ID) of the recognition target object.

First, the optical sensor moving unit 110 moves, for example, 360 degrees with respect to a piled recognition target object and on an installed rail or moving line 111. Here, the optical sensor moving unit 110 may calculate an area of the recognition target object using an encoder that calculates a moving distance.

That is, the optical sensor moving unit 110 may calculate straight-line displacement of the encoder mounted on the optical sensor moving unit 110 to calculate a moving distance of the optical sensor moving unit 110. The optical sensor recognizing unit 120 may detect distance information to a recognition target object at certain intervals while the optical sensor moving unit 110 is moving. A section in which an optical signal returns to the optical sensor recognizing unit 120 may be estimated as a length of one surface of the recognition target object.

The optical sensor recognizing unit 120 is mounted on the optical sensor moving unit 110, and acquires information on the recognition target object using an optical sensor. That is, the optical sensor recognizing unit 120 may radiate source light on the recognition target object, recognize the source light returning from the recognition target object, and acquire the information on the recognition target object using the recognized source light.

Here, the information on the recognition target object may include distance information to the recognition target object, area information of the recognition target object, shape information of the recognition target object, and height information of the recognition target object. Especially, the optical sensor recognizing unit 120 may calculate a zone of received light to recognize an area of the recognition target object, and may recognize the shape information of the recognition target object, namely, in what shape the recognition target object is cut or processed, using a change in the distance information to the recognition target object.

The piling location calculating unit 130 calculates vertical location coordinates of the recognition target object on the basis of the information (calculated by the optical sensor recognizing unit 120) on the recognition target object. Specifically, the piling location calculating unit 130 calculates the vertical location coordinates of the recognition target object using the height information of the recognition target object, and stores the calculated vertical location coordinates of the recognition target, object.

Here, for example, when a new recognition target object is piled up at a place in which other objects having a specific height are piled up, the piling location calculating unit 130 may calculate a height, which is obtained by adding a height of the new recognition target object to the specific height, as vertical location coordinates of the recognition target object.

The identification tag recognizing unit 140 detects an identification tag of the recognition target object, and matches the identification tag with the vertical location coordinates of the recognition target object to calculate piling location information of the recognition target object and detect a unique ID of the recognition, target object.

Moreover, the identification tag recognizing unit 140 transmits the calculated vertical location coordinates of the recognition target object and the calculated piling location information of the recognition target object to a piling management system (see 500 of FIG. 5). At this time, the piling management system (see 500 of FIG. 5) may identify a specific object to move or pile up on the basis of the transmitted vertical location coordinates and piling location information of the recognition target object.

Therefore, in the piling location recognizing apparatus according to an embodiment of the present invention, a location of a recognition target object (for example, a steel material, goods in process, or the like) can be accurately determined within a yard at a manufacturing site of large objects such as ships and plants. Also, despite environmental pollution or damage of an identification tag adhered to a recognition target object at a piling place in which recognition target objects are piled up, an in-yard location of the piled recognition target object can be accurately determined.

In an embodiment of the present invention, calculating the vertical location coordinates has been described above as an example, but in another embodiment of the present invention, the optical sensor recognizing unit may calculate a horizontal location coordinate value which is expressed as a relative distance between the optical sensor and a recognition target object, thus, facilitating work automation, of a magnet type crane that raises a large and heavy object. That is, in pick-up work and drop-off work of a transfer target object, it is easy to calculate a magnet adhesion place suitable for a weight balance.

FIG. 2 is a conceptual diagram illustrating an operating environment of the optical sensor moving unit according to an embodiment of the present invention.

Referring to FIG. 2, the optical sensor moving unit 110 moves, for example, at 360 degrees with respect to a piled recognition target object and on an installed rail or moving line. At this time, the optical sensor recognizing unit 120 mounted on the optical sensor moving unit 110 may detect a distance A from the optical sensor recognizing unit 120 to a recognition target object and height information B of the recognition target object at 360 degrees, thereby detecting a shape and height of the recognition target object in a horizontal direction in all directions of the recognition target object.

The optical sensor moving unit 110 may calculate an area of the recognition target object using the encoder that calculates a moving distance. That is, the optical sensor moving unit 110 may calculate straight-line displacement of the encoder mounted on the optical sensor moving unit 110 to calculate a moving distance of the optical sensor moving unit 110. The optical sensor recognizing unit 120 may detect distance information to a recognition target object at certain intervals while the optical sensor moving unit 110 is to moving. Here, a section in which an optical signal returns to the optical sensor recognizing unit 120 may be estimated as a length of one surface of the recognition target object.

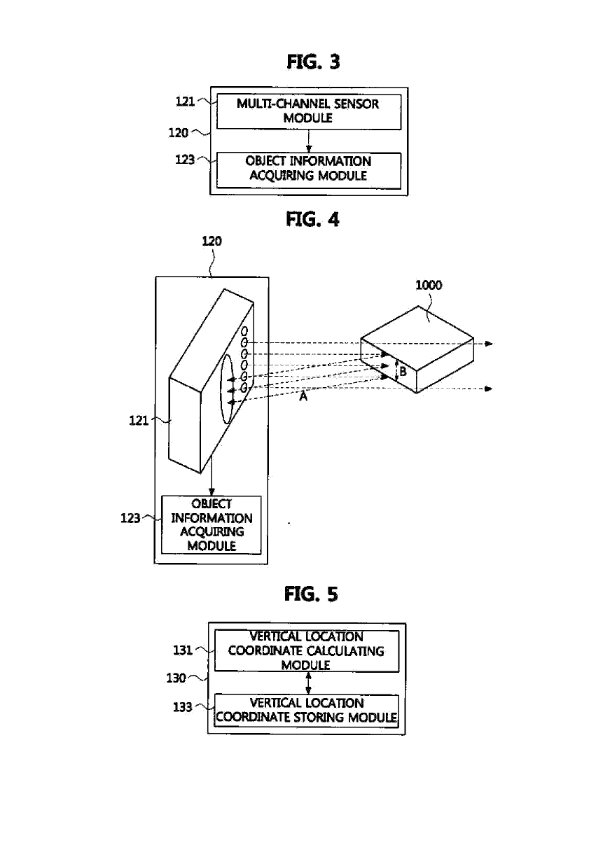

FIG. 3 is a block diagram illustrating modules configuring the optical sensor recognizing unit according to an embodiment of the present invention, and FIG. 4 is a conceptual diagram illustrating an operation performed in the optical sensor recognizing unit according to an embodiment of the present invention.

Referring to FIGS. 3 and 4, the optical sensor recognizing unit 120 may include a multi-channel sensor module 121 and an object information acquiring module 123.

The multi-channel sensor module 121 is configured with a light-emitting unit that radiates source light on a recognition target object and a light-receiving unit that receives the source light returning from the recognition target object.

Here, the light-emitting unit of the multi-channel sensor module 121 may adjust the number of channels and a disposition interval between optical sources depending on a target to which the light-emitting unit is applied, thereby adjusting resolution.

The object information acquiring module 123 may acquire distance information A to the recognition target object, area information of the recognition target object, shape information of the recognition target object, and height information B of the recognition target object using source light recognized by the multi-channel sensor module 121.

Here, the area information and shape information of the recognition target object may be acquired when the optical sensor recognizing unit 120 is mounted on the optical sensor moving unit 110 and moves 360 degrees with respect to the recognition target object.

The object information acquiring module 123 may radiate the source light, supplied from the multi-channel sensor module 121, on the recognition target object, and acquire the height information B of the recognition target object using the returning source light. Specifically, since source light beyond the height B of the recognition target object does not to return, the object information acquiring module 123 may receive the returning source light from the multi-channel sensor module 121 to estimate the height B of the recognition target object.

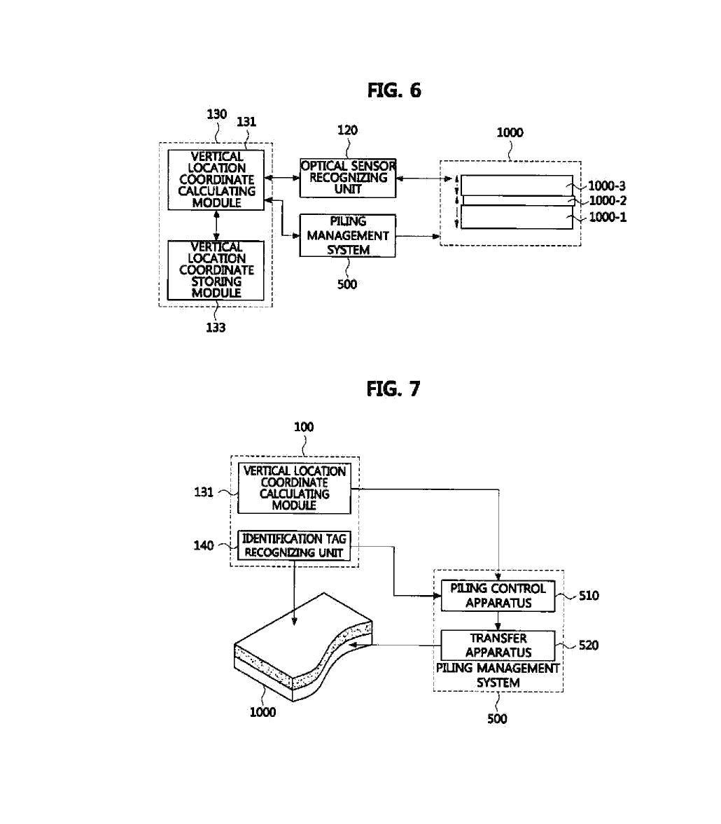

FIG. 5 is a block diagram illustrating modules configuring the piling location calculating unit according to an embodiment of the present invention, and FIG. 6 is a conceptual diagram illustrating an environment in which vertical location coordinates of an object are calculated in the piling location calculating unit according to an embodiment of the present invention.

Referring to FIG. 3, the piling location calculating unit 130 may include a vertical location coordinate calculating module 131 and a vertical location coordinate storing module 133.

The vertical location coordinate calculating module 131 calculates vertical location coordinates of the recognition target object using the height information of the recognition target object supplied from the optical sensor recognizing unit 120, and stores the calculated vertical location coordinates of the recognition target object in the vertical location coordinate storing module 133.

For example, flat heavy objects are mostly piled up by a horizontal piling method in a heavy industry yard such as a dockyard and the like, and thus, when it is assumed that a first object 1000-1 and a second object 1000-2 are piled up, vertical location coordinates of a third object 1000-3 may be calculated as 22 m which is made by adding a height of 7 m of the third object 1000-3 to a height of 15 m which is made by adding a height of 10 m of the first object 1000-1 and a height of 5 m of the second object 1000-2. That is, the vertical location coordinates of the third object 1000-3 may be calculated as 15 m to 22 in.

The vertical location coordinate storing module 133 may store the calculated vertical location coordinates of the recognition target object.

Therefore, according to an embodiment of the present invention, calculating vertical

location coordinates of a flat type object can be automated using height information of a recognition target object which is acquired by the optical sensor recognizing unit 120, and the calculated vertical location coordinates of the object may be transmitted to the piling management system 500 and used in warehousing or releasing the object.

FIG. 7 is a conceptual diagram illustrating, an environment in which piling location information and a unique ID of an object are detected in the identification tag recognizing unit according to an embodiment of the present invention.

Referring to FIG. 7, the identification tag recognizing unit 140 detects an identification tag of a recognition target object, and matches the detected identification tag with vertical location coordinates of the recognition target object to calculate a piling location of the recognition target object and detect a unique ID of the recognition target object.

Here, the identification tag may be, for example, an RF identification (RFID) tag. Also, the identification tag recognizing unit 140 may be, for example, an RFID reader, and may use a far-field type and a near-field type which has a narrow recognition range.

Subsequently, the identification tag recognizing unit 140 transmits the calculated piling location of the recognition target object to a piling control apparatus of the piling management system 500. Also, the vertical location coordinate calculating module 131 transmits the vertical location coordinates stored in the vertical location coordinate storing module 133 to the piling control apparatus 510.

The piling control apparatus 510 performs control in order for a transfer apparatus 520 to accurately move or pile up the recognition target object on the basis of the transmitted vertical location coordinates and piling location of the recognition target object.

Therefore, according to an embodiment of the present invention, by using a piling location of an object which is calculated using the identification tag and vertical location coordinates calculated using the optical sensor, the piling location of the object (for example, a steel material, goods in process, or the like) can be accurately determined at a manufacturing site of large objects such as ships and plants.

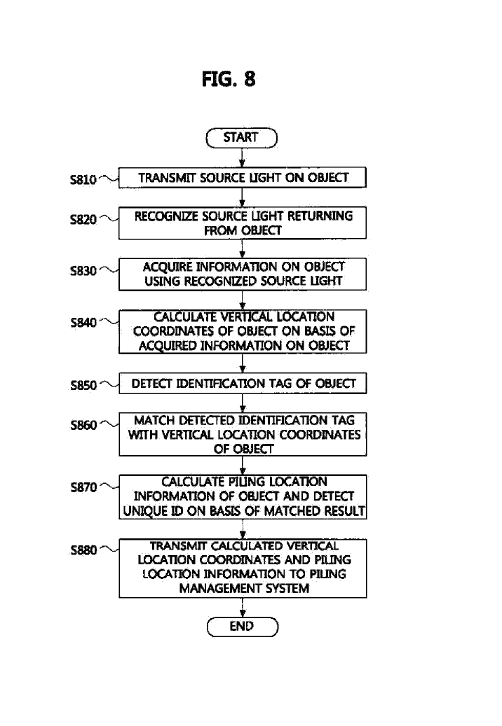

FIG. 8 is a flowchart illustrating a piling location recognizing method according to an embodiment of the present invention.

Referring to FIG. 8, the piling location recognizing apparatus 100 radiates source light on a recognition target object while moving 360 degrees with respect to the recognition target object which is piled up on an installed rail or moving line in operation S810.

The piling location recognizing apparatus 100 radiates source light on the recognition target object in operation S810, and then recognizes the source light returning from the recognition target object in operation S820.

Subsequently, in operation S830, the piling location recognizing apparatus 100 acquires information on the recognition target object using the source light which is recognized in operation S820.

Here, the piling location recognizing apparatus 100 may calculate a surface area of the recognition target object using the source light which is recognized in operation S820.

Specifically, the piling location recognizing apparatus 100 may calculate straight-line displacement of the encoder to calculate a moving distance of the encoder. The piling location recognizing apparatus 100 may detect distance information to the recognition target object at certain intervals while moving. A section in which an optical signal returns to the piling location recognizing apparatus 100 may be estimated as a length of one surface, of the recognition target object.

Moreover, the information on the recognition target object may include distance information to the recognition target object, area information of the recognition target object, shape information of the recognition target object, and height information of the recognition to target object.

Subsequently, in operation S840, the piling location recognizing apparatus 100 calculates vertical location coordinates of the recognition target object on the basis of the information on the recognition target object which is acquired in operation S830. In detail, the piling location recognizing apparatus 100 calculates the vertical location coordinates of the recognition target object using the height information of the recognition target object, and stores the calculated vertical location coordinates of the recognition target object.

For example, when a new object is piled up at a place in which other objects having a specific height are piled up, the piling location recognizing apparatus 100 may calculate a height obtained by adding a height of the new object to the specific height as the vertical location coordinates of the recognition target object.

Moreover, the piling location recognizing apparatus 100 detects an identification tag of the recognition target object in operation S850.

Subsequently, the piling location recognizing apparatus 100 matches the identification tag (which is detected in operation S850) with the vertical location coordinates of the recognition target object in operation S860.

The piling location recognizing apparatus 100 calculates piling location information of the recognition target object and detects a unique ID of the recognition target object, on the basis of the result which is matched in operation S860.

Subsequently, in operation S880, the piling location recognizing apparatus 100 transmits the vertical location coordinates (which are calculated in operation S840) of the recognition target object and the piling location information (which is calculated in operation S870) of the recognition target object to a piling management system (see 500 of FIG. 6).

At this time, the piling management system (see 500 of FIG. 6) may identify a specific object to move or pile up on the basis of the transmitted vertical location coordinates and to piling location information of the recognition target object.

Therefore, in the piling location recognizing method according to an embodiment of the present invention, a location of an object (for example, a steel material, goods in process, or the like) can be accurately determined within a yard at a manufacturing site of large objects such as ships and plants. Also, despite environmental pollution or damage of an identification tag adhered to an object in an environment of a piling place in which objects are piled up, an in-yard location of the piled object can be accurately determined.

According to the embodiments of the present invention, the piling location recognizing apparatus and method sense an object at 360 degrees using the optical sensor to acquire information on the object, and calculate vertical location coordinates of the object on the basis of the acquired information on the object. Also, the piling location recognizing apparatus and method are used to calculate piling location information of the object by recognizing an identification tag of the object, and transmit the calculated vertical location coordinates and piling location information of the object to the piling management system.

Therefore, a location of an object can be accurately determined within a yard at a manufacturing site of large objects such as ships and plants. Also, despite environmental pollution or damage of an identification tag adhered to an object in a piling place in which objects are piled up, an in-yard location of the piled object can be accurately determined.

While the example embodiments of the present invention and their advantages have been described in detail, it should be understood that various changes, substitutions and alterations may be made herein without departing from the scope of the invention.

What is claimed is:

1. A piling location recognizing apparatus comprising:
an optical sensor moving unit configured to move on an installed moving line according to a predetermined angle with respect to a recognition target object;
an optical sensor recognizing unit mounted on the optical sensor moving unit, and configured to acquire information on the recognition target object using a plurality of optical sensors, the optical sensor recognizing unit including the plurality of optical sensors; and
a piling location calculating unit configured to calculate vertical location coordinates of the recognition target object on a basis of the acquired information on the recognition target object.

2. The piling location recognizing apparatus of claim 1, wherein the optical sensor recognizing unit comprises:
a multi-channel sensor module configured to radiate source light on the recognition target object and receive the source light returning from the recognition target object; and
an object information acquiring module configured to acquire at least one of distance information to the recognition target object, area information of the recognition target object, shape information of the recognition target object, and height information of the recognition target object using the recognized source light.

3. The piling location recognizing apparatus of claim 2, wherein the multi-channel sensor module adjusts a number of channels and a disposition interval between optical sources to adjust resolution.

4. The piling location recognizing apparatus of claim 2, wherein the piling location calculating unit comprises:
a vertical location coordinate calculating module configured to calculate vertical location coordinates of the recognition target object using the height information of the recognition target object, and transmit the calculated vertical location coordinates of the recognition target object to a piling management system that manages a plurality of objects; and
a vertical location coordinate storing module configured to store the calculated vertical location coordinates of the recognition target object.

5. The piling location recognizing apparatus of claim 4, wherein, when the recognition target object is piled up at a place in which other objects having a specific height are piled up, the vertical location coordinate calculating module calculates a height obtained by adding a height of the recognition target object to the specific height as vertical location coordinates of the recognition target object.

6. The piling location recognizing apparatus of claim 1, further comprising an identification tag recognizing unit configured to detect an identification tag of the recognition target object, and match the detected identification tag with the vertical location coordinates of the recognition target object to calculate piling location information of the recognition target object and detect a unique ID of the recognition target object.

7. The piling location recognizing apparatus of claim 6, wherein the identification tag recognizing unit transmits the calculated piling location information to a piling management system that manages a plurality of objects.

8. A piling location recognizing method comprising:
moving a predetermined angle with respect to a recognition target object to acquire information on the recognition target object using an optical sensor; and
calculating vertical location coordinates of the recognition target object on a basis of the acquired information on the recognition target object.

9. The piling location recognizing method of claim 8, further comprising:
recognizing the information on the recognition target object;
radiating source light on the recognition target object;
receiving the source light returning from the recognition target object; and
acquiring at least one of distance information to the recognition target object, area information of the recognition target object, shape information of the recognition target object, and height information of the recognition target object using the recognized source light.

10. The piling location recognizing method of claim 9, wherein the recognizing of the information comprises adjusting a number of channels and a disposition interval between optical sources to adjust resolution.

11. The piling location recognizing method of claim 9, wherein the calculating of vertical location coordinates comprises, when the recognition target object is piled up at a place in which other objects having a specific height are piled up, calculating a height obtained by adding a height of the recognition target object to the specific height as vertical location coordinates of the recognition target object.

12. The piling location recognizing method of claim 8, further comprising:
detecting an identification tag of the recognition target object;
matching the detected identification tag with the vertical location coordinates of the recognition target object; and
calculating piling location information of the recognition target object, and detecting a unique ID of the recognition target object according to the matched result.

13. The piling location recognizing method of claim 12, further comprising, after the calculating of piling location information of the recognition target object and the detecting of a unique ID, transmitting the calculated vertical location coordinates and piling location information to a piling management system.
